(19) United States
(12) Patent Application Publication
(10) Pub. No.: US 2024/0036209 A1
(43) Pub. Date: Feb. 1, 2024

(54) OPTICAL SENSOR CAPABLE OF CANCELLING INTERFERENCE

(71) Applicant: PIXART IMAGING INC., Hsin-Chu County (TW)

(72) Inventors: Tso-Sheng TSAI, Hsin-Chu County (TW); Yueh-Lin CHUNG, Hsin-Chu County (TW)

(21) Appl. No.: 17/878,057

(22) Filed: Aug. 1, 2022

(51) Int. Cl. G01S 17/894; G01S 7/4865; G01S 7/481

(52) U.S. Cl. CPC G01S 17/894; G01S 7/4866; G01S 7/4816

(57) ABSTRACT

There is provided an optical sensor including a light source, a first pixel, a second pixel and a processor. The first pixel generates a first output signal by receiving reflected light from an external object illuminated by the light source. The second pixel generates a second output signal by receiving reflected light from an inner surface of a package illuminated by the light source. The processor generates a random code according to the second output signal to modulate the light source, identifies whether to change an emission pattern of the light source according to a distance calculated according to the first output signal, and changes exposure intervals of the first pixel and the second pixel.

### BACKGROUND

### 1. Field of the Disclosure

This disclosure generally relates to an optical sensor and, more particularly, to a TOF sensor that cancels interference from another TOF sensor, crosstalk from smudges on the TOF sensor and other objects to be detected by modulating a light source using a random code, updating a calibration value and changing a sampling period.

### 2. Description of the Related Art

The time of flight (TOF) technique nowadays is mainly divided into direct TOF (dTOF) and indirect TOF (iTOF).

In the dTOF, a light emitter is used to emit a light pulse, and then a clock signal in a detector is used to count a flying time of the light pulse after the light pulse is reflected by an object to be detected and then reaches the detector. However, if it is desired to implement a high resolution sensing, the dTOF system needs to use a clock signal having an extremely high frequency such that the circuit design difficulty is increased.

In the iTOF, a light emitter is used to emit a continuous light wave, and then a detector is used to detect a reflected light wave reflected by an object to be detected and reaches the detector. By calculating a phase delay of the reflected light wave from the continuous light wave, it is able to obtain a flying time.

Although the iTOF needs not to use a clock signal with an extremely high frequency to obtain the required temporal resolution, the signal aliasing can easily occur such that it is not able to distinguish multiple objects to be detected and crosstalk. Furthermore, the iTOF sensing can be interfered by other TOF sensors nearby.

Accordingly, it is necessary to provide a time of flight sensor that can cancel the interference from other TOF sensors, crosstalk from smudges on the device itself and other objects to be detected.

### SUMMARY

The present disclosure provides an optical sensor that uses the reference pixel(s) to generate a random code for modulating a light source and a sampling signal to distinguish different optical sensors.

The present disclosure further provides an optical sensor that detects a current crosstalk for updating a recorded calibration value so as to adaptably cancel the crosstalk interference.

The present disclosure further provides an optical sensor that uses an adjustable sampling period to detect a phase delay of a reflected light wave for multiple times within a light-off interval to accomplish multiple objects detection.

The present disclosure provides an optical sensor including a light source, a light sensor and a processor. The light source is configured to illuminate light according to a light source driving signal. The light sensor is recorded with an event threshold corresponding to an exposure interval, and includes a first pixel and a second pixel. The first pixel is configured to sample according to a sampling signal. The second pixel is configured to respectively acquire reference photon events using multiple of the exposure intervals. The processor is configured to compare a number of the reference photon events of each of the multiple exposure intervals with the event threshold to generate a random code, and modulate the light source driving signal and the sampling signal using the random code.

The present disclosure further provides an optical sensor including a light source, a pixel and a processor. The light source is configured to illuminate light according to a light source driving signal to cause the light source to have a lighting interval and an extinction interval within one operation period. The pixel is configured to acquire photon events according to a sampling signal corresponding to the lighting interval and the extinction interval identical to each other. The processor is configured to calculate an object distance according to the photon events using indirect time-of-flight, and upon the object distance being larger than a predetermined distance, change the extinction interval to be longer than the lighting interval.

The present disclosure further provides an optical sensor including a light source, a pixel and a processor. The light source is configured to illuminate light according to a light source driving signal to cause the light source to have a lighting interval shorter than an extinction interval within one operation period. The pixel is configured to respectively acquire photon events within at least three sampling periods according to a sampling signal. The processor is configured to calculate at least two object distances respectively according to a ratio of numbers of the photon events of two adjacent sampling periods among the at least three sampling periods.

### BRIEF DESCRIPTION OF THE DRAWINGS

Other objects, advantages, and novel features of the present disclosure will become more apparent from the following detailed description when taken in conjunction with the accompanying drawings.

FIG. 1 is a schematic diagram of an optical sensor according to an embodiment of the present disclosure.

FIG. 2 is a block diagram of an optical sensor according to an embodiment of the present disclosure.

FIG. 3 is a schematic diagram of an optical sensor of the present disclosure which detects photon events for multiple times.

FIG. 4 is a schematic diagram of a probability distribution of the photon events detected by the optical sensor in FIG. 3.

FIG. 5 is a schematic diagram of generating a random code according the probability distribution in FIG. 4 for modulating a light source driving signal and a sampling signal.

FIG. 6 is a signal timing diagram of an optical sensor according to an embodiment of the present disclosure.

FIG. 7 is a signal timing diagram of the crosstalk detection of an optical sensor according to an embodiment of the present disclosure.

FIG. 8 is a flow chart of an operating method of an optical sensor according to an embodiment of the present disclosure.

FIGS. 9A and 9B are signal timing diagrams of an optical sensor for detecting multiple objects according to some embodiments of the present disclosure.

### DETAILED DESCRIPTION OF THE EMBODIMENT

It should be noted that, wherever possible, the same reference numbers will be used throughout the drawings to refer to the same or like parts.

The optical sensor, using a time of flight (TOF) sensor as an example, but not limited to, of the present disclosure is to distinguish different optical sensors by modulating a light source driving signal, and to cancel crosstalk interference by updating a stored calibration value, and further to distinguish multiple objects to be detected by adjusting lengths of multiple sampling periods within one extinction interval.

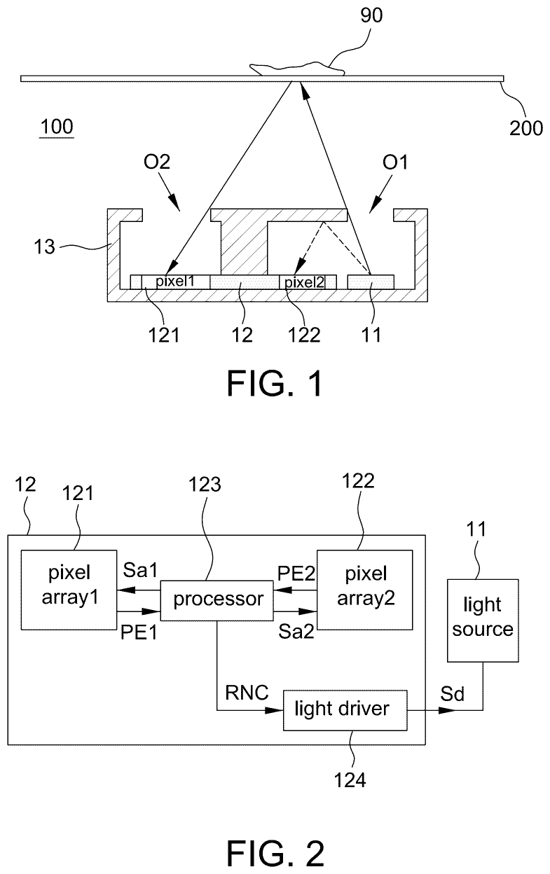

Please refer to FIGS. 1 and 2, FIG. 1 is a schematic diagram of a time of flight (TOF) sensor 100 according to an embodiment of the present disclosure, wherein a protection cover 200 is arranged in front of the TOF sensor 100. The protection cover 200 is disposed on, for example, device housing, and made of glass or plastic, but not limited to. FIG. 2 is a block diagram of a TOF sensor 100 according to an embodiment of the present disclosure.

The TOF sensor 100 includes a light source 11 and a light sensor 12 arranged inside a package 13. The package 13 has a first opening O1 opposite to the light source 11 allowing light to penetrate therethrough.

The light source 11 is a coherent light source or a non-coherent light source, e.g., a light emitting diode or a laser diode. The light source 11 is lighted on or lighted off according to a light source driving signal Sd.

The light sensor (e.g., a sensor chip) 12 includes a first pixel 121 and a second pixel 122, wherein the first pixel 121 and the second pixel 122 respectively include a single photon avalanche diode (SPAD) or multiple SPADs (e.g., forming a pixel array). The operation of the SPAD for detecting photon events is known to the art, and thus is not described herein.

The first pixel 121 receives reflected light from an object outside the package 13 and illuminated by the light source 11. The package 13 has a second opening O2 opposite to the first pixel 121 allowing light to penetrate therethrough. The second pixel 122 receives reflected light directly from an inner surface of the package 13 illuminated by the light source 11, as shown in FIG. 1. That is, the second pixel 122 and the light source 11 are arranged in the same accommodation space of the package 13.

It should be mentioned that although FIGS. 1 and 2 show that the first pixel 121 and the second pixel 122 are on the same chip, the present disclosure is not limited thereto. In another aspect, the first pixel 121 and the second pixel 122 are on different chips, respectively.

The processor 123 is, for example, an application specific integrated circuit (ASIC), a field programmable gate array (FPGA) or a digital signal processor (DSP), which is manufactured inside the light sensor 12 to respectively control the first pixel 121 and the second pixel 122 (respectively shown as an array in FIG. 2, but not limited to) to sample and count photon events using sampling signals Sa1 and Sa2, and to receive a number of photon events PE1 and PE2 from the first pixel 121 and the second pixel 122. The processor 123 drives the light source 11 via, e.g., a light source driver 124 using a light source driving signal Sd. In another aspect, the light source driver 124 is implemented by a hardware circuit and arranged inside the processor 123.

In another aspect, the processor 123 includes multiple counters to count PE1 and PE2. The method of counting photon events detected by SPAD using counters may be referred to U.S. patent application Ser. No. 16/258,673, entitled “IMAGE SENSOR EMPLOYING AVALANCHE DIODE” filed on Jan. 28, 2019, and assigned to the same assignee of the present application, and the full disclosure of which is incorporated herein by reference.

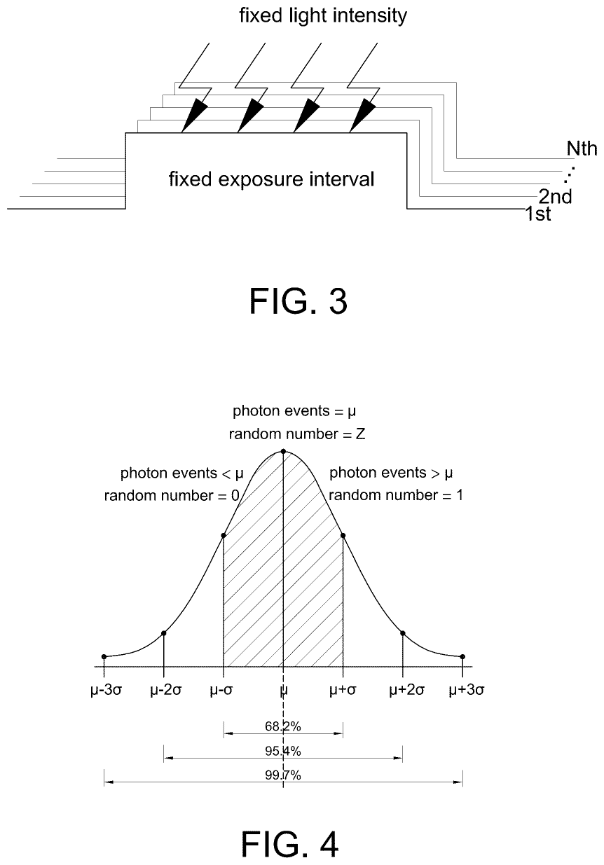

In the present disclosure, in order to distinguish emission light from different devices (e.g., other TOF sensors nearby), the light sensor 12 records (e.g., by eFuse or in OPT memory) an event threshold μ corresponding to an exposure interval. The event threshold μ is a highest number of photon events, e.g., a peak in FIG. 4, of a probability distribution of multiple photon events previously acquired (e.g., before shipment) by the second pixel 122 using multiple exposure intervals, e.g., N times shown in FIG. 3.

For example referring to FIG. 3, before shipment, the light source 11 is lighted with a fixed light intensity; and the processor 123 controls the second pixel 122 to capture reflected light from an inner surface of the package 13 using a proper exposure interval. As shown in FIG. 3, the second pixel 122 samples N-times of exposure intervals using a fixed exposure interval. Next, a number of photon events respectively obtained in the N-times exposure is used to form a probability distribution as shown in FIG. 4, which is close to a random distribution based on the nature of SPAD. Finally, the highest number of photon events in the probability distribution e.g., μ=(1/N)×ΣPEi is set as an expected value, where PEi is a number of photon events detected in the ith exposure among the N-times of exposure. In the present disclosure, the expected value μ is set as the event threshold to be recorded in the light sensor 12.

Because a number of photon events within an exposure interval is affected by a length of the exposure interval, the exposure interval is also previously determined. In the present disclosure, the exposure interval is selected based on a number of photon events at the peak minus a 3 times of standard deviation σ (=μ^{1/2}) in the probability distribution (i.e. μ−3σ) being larger than 0, and a number of photon events at the peak plus a 3 times of standard deviation (i.e. μ+3σ) in the probability distribution being smaller than a saturation of the second pixel 122. The determined exposure interval is also recorded (e.g., by eFuse or in OPT memory) in the TOF sensor 100 (e.g., light sensor 12 thereof, but not limited to).

During actual operation, the processor 13 controls the second pixel 122 to respectively acquire reference photon events PE2 using multiple exposure intervals (identical to the recorded exposure interval). The processor 123 then compares a number of reference photon events PE2 of each of the multiple exposure intervals with the event threshold μ to generate a random code RNC, and uses the random code RNC to modulate the light source driving signal Sd and the sampling signal (including Sa1 and Sa2).

Please refer to FIG. 4, when the number of reference photon events PE2 is larger than the event threshold μ, the random code RNC is set as 1; when the number of reference photon events PE2 is smaller than the event threshold μ, the random code RNC is set as 0, or vice versa. When the number of reference photon events PE2 is equal to the event threshold μ, the random code RNC is no generated (shown as Z). Then, the processor 123 identifies whether a number of next reference photon events PE2 is larger than or smaller than the event threshold μ to determine a next random code RNC.

In this embodiment, if the second pixel 122 includes one SPAD, the random code RNC is one bit; and if the second pixel 122 includes two SPADs, the random code RNC is two bits. More specifically, if the second pixel 122 is an array, the array is selected to be divided into multiple regions to perform the coding with multiple bits, and each of the multiple regions includes one SPAD or multiple SPADs.

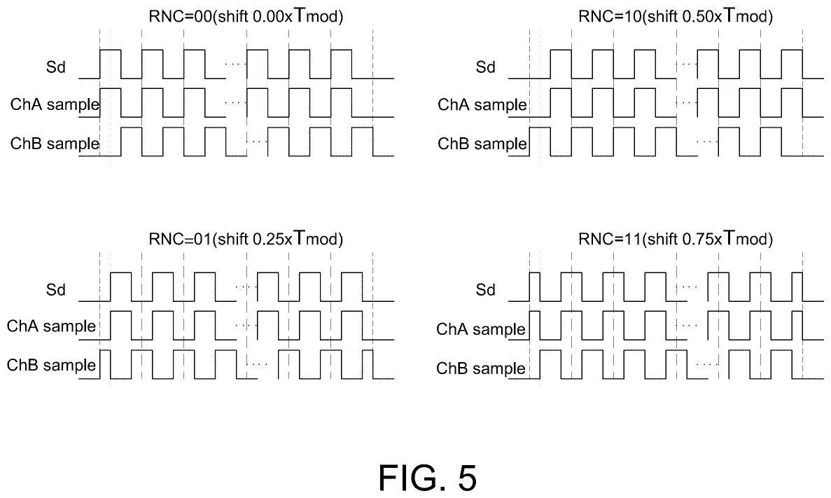

For example referring to FIG. 5, it is a signal timing diagram of modulating the light source driving signal Sd and the sampling signal Sa1 (including ChA and ChB) using the random code RNC having two-bits. The method of using two out-of-phase sampling signals in the iTOF is known to the art, and thus is not described herein. In one aspect, the processor 123 modulates the light source driving signal Sd and the sampling signal using the phase shift keying according to the random code RNC. For example, if the random code RNC is one bit, the phase without being shifted (i.e. 0.00×Tmod) and shifted by 0.5 square periods (i.e. 0.50×Tmod), as shown in FIG. 5, can be used as a modulation scheme.

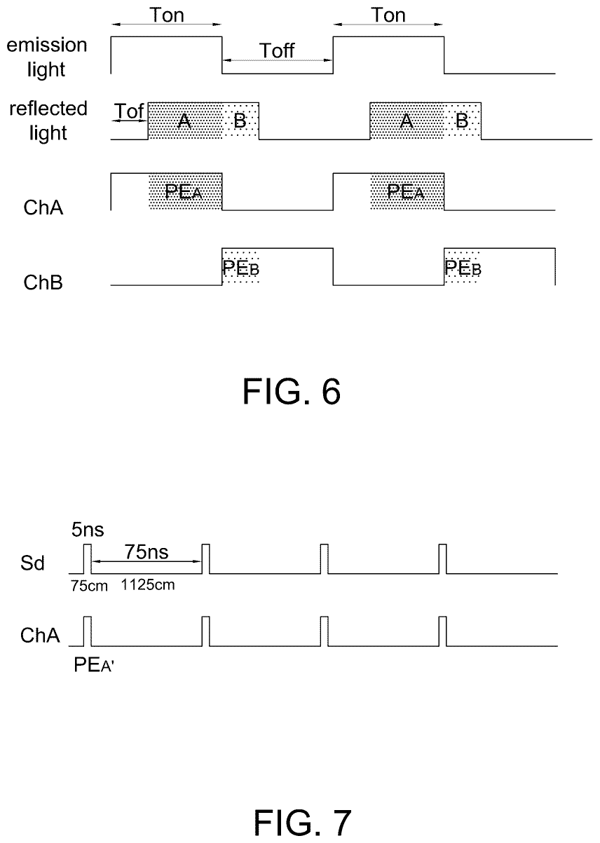

Please refer to FIG. 6, it is an operational schematic diagram of a TOF sensor 100 according to one embodiment of the present disclosure. As shown in FIG. 6, the light source 11 emits light according to a light source driving signal (shown as emission light) such that the light source 11 has a lighting interval Ton and an extinction interval Toff within one operation period. As mentioned above, in the iTOF, the lighting interval Ton is equal to the extinction interval Toff. The processor 123 calculates an object distance according a delay time (shown as ToF) between the emission light and the reflected light. The first pixel 121 receives a sampling signal Sa (including ChA and ChB) to acquire photon events, e.g., a counting of photon events corresponding to a high level of the sampling signal ChA is shown as PE_{A}, and a counting of photon events corresponding to a high level of the sampling signal ChB is shown as PE_{B}.

The processor 123 calculates the object distance using the iTOF according to the photon events PE_{A} and PE_{B}. e.g., object distance=(c/2)×(PE_{B}/PE_{A}+PE_{B})×Ton, where c is light speed. When the calculated object distance is larger than a predetermined distance, the processor 123 changes the extinction interval Toff to be larger than the lighting interval Ton, e.g., the extinction interval Toff larger than 2 times of the lighting interval Ton, and FIG. 7 showing 15-times (Ton=5 nm and Toff=75 nm), but the present disclosure is not limited thereto.

In one aspect, the processor 123 does not change the lighting interval Ton, and only extends the extinction interval Toff, but not limited to. In another aspect, the processor 123 adjusts lengths of both the lighting interval Ton and the extinction interval Toff.

This embodiment is to cancel the crosstalk interference caused by reflected light from the protection cover 200 in front of the TOF sensor 100 and smudges (including dust and oil if there are) 90 on the protection cover 200.

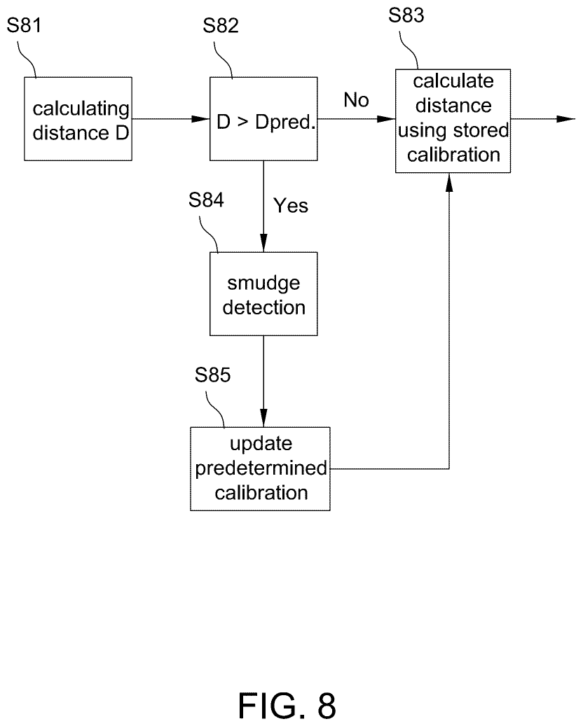

Please refer to FIG. 8, it is a flow chart of an operating method of a TOF sensor 100 according to an embodiment of the present disclosure, including the steps of: calculating an object distance (shown as D) according to photon events detected by a first pixel (Step S81); comparing the object distance and a predetermined distance, shown as Dpred. (Step S82); upon the object distance being smaller than the predetermined distance, directly subtracting a predetermined calibration value from the photon events to calculate and output an object distance (Step S83); upon the object distance being larger than the predetermined distance, performing a smudge detection (Step S84); and updating the predetermined calibration value (Step S85).

This operating method is automatically performed every time the TOF sensor 100 is provided with electricity or instructed by a user command (e.g., pushing a button or clicking an icon).

Step S81: Before operation, the TOF sensor 100 (e.g., the light sensor 12) previously records a predetermined calibration value (e.g., including PE_{Ar} and PE_{Br}, wherein PE_{Ar} is for calibrating PE_{A}, and PE_{Br} is for calibrating PE_{B}), which is a number of photon events contributed by reflected light from the protection cover 200, e.g., measured before shipment. Accordingly, in calculating the object distance according to the photon events PE_{A} and PE_{B} detected by the first pixel 121, said photon events are subtracted by the predetermined calibration value to obtain a calibrated object distance, e.g., the calibrated object distance=

(c/2)×[(PE_{B}−PE_{Br})/(PE_{A}×PE_{Ar})+(PE_{B}−PE_{Br})]×Ton (1)

Step S82-S83: When the calculated distance according to equation (1) is smaller than a predetermined distance, it means that said photon events detected by the first pixel 121 also contains reflected light from the protection cover 200 and the smudge 90, non-distinguishable, and thus the processor 123 does not change any setting and uses the equation (1) to calculate the object distance.

Step S82 and S84: When the calculated distance according to equation (1) is larger than a predetermined distance, it means that said photon events detected by the first pixel 121 only contains reflected light from the protection cover 200 and the smudge 90. If the circuit design difficulty of generating the light source driving signal Sd is not considered, the predetermined distance (corresponding to a width of Sd) is selected to be as close to a distance of the protection cover 200 as possible. Because smudges 90 accumulated on the protection cover 200 may be increased after continuous usage of the TOF sensor 100, the variation of the smudges 90 are detected using the smudge detection in Step S84.

In the smudge detection of Step S84, the processor 123 changes the extinction interval Toff to be larger than the lighting interval Ton, as shown in FIG. 7. Next, the processor 123 controls the first pixel 121 using a sampling signal ChA to acquire calibration photon events corresponding to the lighting interval Ton, e.g., shown as PE_{A}′, which is considered as a current contribution of reflected light from the protection cover 200 and the smudge 90. Meanwhile, PE_{B}′ is obtainable using a ratio (PE_{Br}/PE_{Ar}).

In another aspect, the processor 123 uses two sampling signals ChA and ChB similar to FIG. 6 to respectively acquire PE_{A}′ and PE_{B}′.

Step S85: Finally, the processor 123 replaces (or updates) PE_{Ar} and PE_{Br} using the PE_{A}′ and PE_{B}′, and then calculates an object distance using equation (2)

(c/2)×[(PE_{B}−PE_{B}′)/(PE_{A}−PE_{A}′)+(PE_{B}−PE_{B}′)]×Ton (2)

Accordingly, the crosstalk interference of the device itself can be cancelled, and the calibration value is continuously updated and recorded according to the usage conditions so as to increase the detection accuracy.

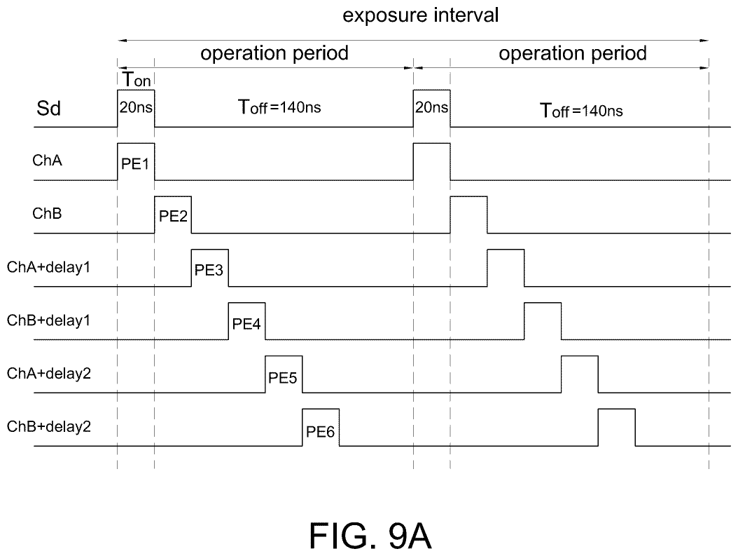

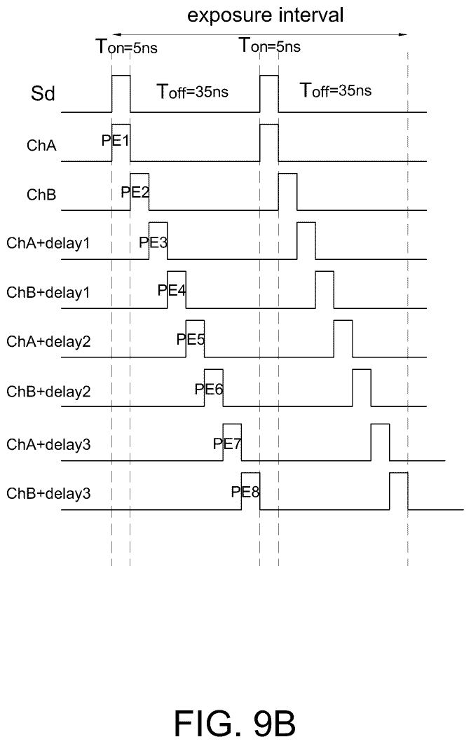

Please refer to FIG. 9A, it is an operational schematic diagram of a TOF sensor 100 according to an embodiment of the present disclosure. In FIG. 9A, the light source 11 emits light according to a light source driving signal Sd such that the light source 11 has a lighting interval Ton smaller than a extinction interval Toff within one operation period, e.g., Toff larger than or equal to 2 times of Ton. The first pixel 121 respectively acquires photon events, e.g., shown as PE1 to PE6 within at least three sampling periods (e.g., shown as 6 sampling periods, but not limited to) according to sampling signals ChA, ChB, ChA+delay and ChB+delay. As shown in FIG. 9A, among the at least three sampling periods, a start (shown as signal's rising edge) of a later sampling period is aligned with an end (shown as signal's falling edge) of a previous sampling period.

In this embodiment, a number of sampling periods within the extinction interval Toff is determined according to an expected distance detection range of the TOF sensor 100. When the expected distance detection range is larger, the extinction interval Toff is selected to be longer and the number of the sampling periods is selected to be larger; whereas, when the expected distance detection range is shorter, the extinction interval Toff is selected to be shorter and the number of the sampling periods is selected to be smaller. The sampling periods are not limited to be continuous to an end of the extinction interval Toff as long as a first sampling interval (e.g., an interval corresponding to photon events PE1) among the at least three sampling periods is corresponding to the lighting internal Ton and the rest sampling intervals are corresponding to or within the extinction interval Toff.

The processor 123 calculates at least two object distances respectively according to a ratio of numbers of photon events of two adjacent sampling periods. For example, a first object distance=(c/2)×(PE₂/PE₁+PE₂)×Ton; a second object distance=(c/2)×(PE₃/PE₂+PE₃)×Ton+delay (shown as delay1); a third object distance=(c/2)×(PE₄/PE₃+PE₄)×Ton+2×delay (shown as delay2): and so on. That is, the processor 123 further adds a delay distance in calculating the object distance using two adjacent sampling periods behind a first sampling period among the at least three sampling periods.

The delay distance is determined according to lengths of the sampling periods and the lighting interval Ton. For example as shown in FIG. 9A, if the sampling period is 20 nm, the delay distance is 300 centimeters. In this way, by acquiring multiple photon events within a longer extinction period Toff, it is able to achieve the effect of distinguishing multiple objects to be detected, similar to the dTOF.

Furthermore, the present disclosure further calibrates a distance resolution by changing lengths of the lighting interval Ton and the sampling periods. For example, in the first measurement (e.g., called rough measurement), 20 nm shown in FIG. 9A is used as the lighting interval Ton and sampling periods. and the distance resolution is 300 centimeters. After a rough distance is obtained, a 5 nm shown in FIG. 9B is used as the lighting interval Ton and sampling periods to perform a second measurement (e.g., called fine measurement), and the distance resolution is 75 centimeters. The shorter sampling period is, the distance resolution is higher, and a higher number of sampling periods can distinguish more objects to be detected.

Moreover, after a distance is obtained in the first measurement, a length of the extinction interval Toff can be decreased so as to increase the detection speed.

It should be mentioned that values, including time intervals, code bits and a number of sampling periods, mentioned in the above embodiments are only intended to illustrate but not to limit the present disclosure.

Furthermore, the above embodiments are combinable to one another to form another embodiment, e.g., the random code RNC and the calibration value obtained using the second pixel 122 can be applied to all embodiments of the present disclosure.

In the present disclosure, in addition to be used as a random number generator, the second pixel 122 can also be used to compensate a temperature dependence of the detection result of the first pixel 121, e.g., referring to U.S. patent application Ser. No. 16/936,777, entitled “TIME OF FLIGHT SENSOR CAPABLE OF COMPENSATING TEMPERATURE DEVIATION AND TEMPERATURE COMPENSATION METHOD THEREOF” filed on Jul. 23, 2020, and assigned to the same assignee of the present application, and the full disclosure of which is incorporated herein by reference.

As mentioned above, it is difficult for the conventional iTOF technique to distinguish interference from multiple objects to be detected, crosstalk and other TOF devices. Therefore, the present disclosure further provides a time of flight sensor capable of cancelling interference (as shown in FIGS. 1-2) that distinguishes difference TOF devices by providing real-time random codes for modulating the light source and sampling signal(s), cancels the crosstalk issue by updating a calibration value, and detects multiple objects using multiple sampling periods, which has the effect similar to the dTOF.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

What is claimed is:

1. An optical sensor, comprising:
a light source, configured to illuminate light according to a light source driving signal;
a light sensor, recorded with an event threshold corresponding to an exposure interval, and comprising:
a first pixel, configured to sample according to a sampling signal, and
a second pixel, configured to respectively acquire reference photon events using multiple of the exposure intervals, and
a processor, configured to
compare a number of the reference photon events of each of the multiple exposure intervals with the event threshold to generate a random code, and
modulate the light source driving signal and the sampling signal using the random code.

2. The optical sensor as claimed in claim 1, further comprising a package, wherein
the second pixel is configured to receive reflected light from an inner surface of the package illuminated by the light source, and
the first pixel is configured to receive reflected light from an object outside the package illuminated by the light source.

3. The optical sensor as claimed in claim 1, wherein
the event threshold is a number of photon events of a peak of a probability distribution of multiple photon events previously acquired by the second pixel using multiple of the exposure intervals.

4. The optical sensor as claimed in claim 3, wherein
upon the number of the reference photon events is larger than the event threshold, the random code is set as 1,
upon the number of the reference photon events is smaller than the event threshold, the random code is set as 0, and
upon the number of the reference photon events is equal to the event threshold, the random code is not generated.

5. The optical sensor as claimed in claim 4, wherein the exposure interval is selected based on
a number of photon events at the peak minus a 3 times of standard deviation in the probability distribution being larger than 0, and
a number of photon events of at the peak plus a 3 times of standard deviation in the probability distribution being smaller than a saturation of the second pixel.

6. The optical sensor as claimed in claim 1, wherein
the processor is configured to modulate the light source driving signal and the sampling signal using phase shift keying according to the random code.

7. The optical sensor as claimed in claim 1, wherein
the second pixel comprises one single photon avalanche diode, and
the random code has one bit.

8. The optical sensor as claimed in claim 1, wherein
the second pixel comprises two single photon avalanche diodes, and
the random code has two bits.

9. An optical sensor, comprising:
a light source, configured to illuminate light according to a light source driving signal to cause the light source to have a lighting interval and an extinction interval within one operation period;
a pixel, configured to acquire photon events according to a sampling signal corresponding to the lighting interval and the extinction interval identical to each other; and
a processor, configured to
calculate an object distance according to the photon events using indirect time-of-flight, and
upon the object distance being larger than a predetermined distance, change the extinction interval to be longer than the lighting interval.

10. The optical sensor as claimed in claim 9, wherein the extinction interval is changed to be longer than 2-times of the lighting interval.

11. The optical sensor as claimed in claim 9, wherein when the object distance is smaller than the predetermined distance, the processor is configured to subtract a predetermined calibration value from the photon events.

12. The optical sensor as claimed in claim 11, wherein the processor is further configured to
control the pixel to acquire calibration photon events corresponding to the lighting interval using another sampling signal, and
updating the predetermined calibration value using the calibration photon events.

13. The optical sensor as claimed in claim 11, further comprising a protection cover in front of the light source and the pixel, wherein the predetermined calibration value is a number of photon events contributed by reflected light from the protection cover.

14. The optical sensor as claimed in claim 9, wherein the processor is configured to extend the extinction interval without changing the lighting interval.

15. An optical sensor, comprising:
a light source, configured to illuminate light according to a light source driving signal to cause the light source to have a lighting interval shorter than an extinction interval within one operation period;
a pixel, configured to respectively acquire photon events within at least three sampling periods according to a sampling signal; and
a processor, configured to calculate at least two object distances respectively according to a ratio of numbers of the photon events of two adjacent sampling periods among the at least three sampling periods.

16. The optical sensor as claimed in claim 15, wherein a number of the sampling periods is determined according to an expected detection distance range of the optical sensor.

17. The optical sensor as claimed in claim 15, wherein the processor is further configured to change lengths of the lighting interval and the sampling periods to calibrate a distance resolution.

18. The optical sensor as claimed in claim 15, wherein among the at least three sampling periods, a start of a later sampling period is aligned with an end of a previous sampling period.

19. The optical sensor as claimed in claim 15, wherein among the at least three sampling periods, a first sampling period is corresponding to the lighting interval, and the rest sampling periods are corresponding to the extinction interval.

20. The optical sensor as claimed in claim 15, wherein the processor is further configured to add a delay distance in calculating the object distance using the two adjacent sampling periods behind a first sampling period among the at least three sampling periods.
